(19) United States
(12) Patent Application Publication
(10) Pub. No.: US 2008/0236668 A1
(43) Pub. Date: Oct. 2, 2008

(54) Microfluidic Valve

(76) Inventors: Timothy Beerling, San Fracisco, CA (US); Reld A. Brennen, San Francisco, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/691,318

(22) Filed: Mar. 26, 2007

(51) Int. Cl. F17D 3/00; F17D 1/00

(52) U.S. Cl. 137/2; 137/625

(57) ABSTRACT

A microfluidic valve. A microfluidic channel is formed in a substrate. A cooling element cools a substance in the channel to inhibit flow of the substance through the channel. A heating element warms the substance to overcome the effect of the cooling and enable the substance to flow through the channel. The valve may serve as a component of a microfluidic device that in turn may be part of a microfluidic system.

### BACKGROUND

Microfluidic systems are used for analyzing and characterizing samples on a molecular scale. Assays have been designed to execute directly on such microfluidic devices. Solutions are mixed and processes are carried out by means of valves that release precise amounts of reagents over time.

### DESCRIPTION OF THE DRAWINGS

FIG. 1 is a cross-sectional view of a microfluidic valve embodying the invention.

FIG. 2 is a plan view of a microfluidic device embodying the invention.

FIG. 3 is a block diagram of a microfluidic system embodying the invention.

FIG. 4 is a flow chart of a method embodying the invention.

### DESCRIPTION OF THE EMBODIMENTS

As shown in FIG. 1, a microfluidic valve 6 embodying the invention includes a substrate 7 defining a microfluidic channel 8, a cooling element 10 adjacent the microfluidic channel that cools a substance in the microfluidic channel sufficiently to inhibit flow of the substance through the microfluidic channel, and a heating element 9 adjacent the microfluidic channel that warms the substance sufficiently to overcome the cooling effect of the cooling element and thereby enable flow of the substance through the microfluidic channel.

In some embodiments the cooling element 10 operates continuously to maintain the channel in a closed state by cooling or freezing the substance, which may be a liquid, a solution, or a gel, in the channel. The heating element 9 may then be activated to place the channel in an open state by heating the substance in the channel, thereby allowing flow.

The substrate 7 may comprise a single layer or (as in the embodiment shown) a plurality of layers 11 and 13 joined together to form the microfluidic channel 8. For example, a first layer 11 having a depression in a surface thereof may be covered by a second layer 13 to form the microfluidic channel in the depression. The two layers need not be made of the same material, and it may be desirable to use materials that differ from each other in such characteristics as thermal conductivity and optical transparency. Materials that may be used include various types of polymers, metals, semiconductors (such as silicon), glasses, ceramics, and composite materials. Depending on the material used, the microfluidic channel may be formed by such techniques as shaping, machining, micromachining, etching, laser ablation, or molding. For example, the microfluidic channel may be etched in a photo-definable polymer.

The microfluidic channel 8 may comprise a variety of shapes, sizes and volumes. It may be designed to intersect or connect with other microfluidic channels for mixing various materials and solutions at various stoichiometric ratios or for moving, reacting, switching, pumping, separating, analyzing or modifying substances such as fluids, solutions or gels.

The cooling element 10 may be any device that can remove heat from a substance in the micro fluidic channel. Such a device may be convective or conductive. The cooling element may comprise a hollow conduit that contains a fluid coolant. Such a coolant may be circulated from another location. The cooling element may be a thermoelectric device or a Peltier device. A cooling block 15 may be formed on an upper surface 16 of the cooling element 10, for example by micromachining the surface 16, to more effectively transfer heat directly away from a portion of the substrate adjacent the immediate vicinity of the microfluidic channel 8 and avoid heat transfer elsewhere.

The heating element 9 is located near or in the microfluidic channel 8. In some embodiments the heating element is separated from the microfluidic channel by one or more layers of material 12 and 14 that facilitate the flow of heat from the heating element to the substance in the microfluidic channel. The heating element may comprise a portion of the substrate 7 or may be disposed in or on the substrate.

The heating element may comprise a source of electromagnetic energy wherein heating occurs when the energy impinges on the substance in the microfluidic channel. Or the heating element may comprise both a source of electromagnetic energy and a block of material which is heated by absorption of the energy and which then transfers the heat to the substance in the microfluidic channel 8. The electromagnetic energy may be of any desired wavelength from RF radiation to and perhaps even above the visible light spectrum; for example, the heating element may comprise a laser, a maser, or a microwave energy source. Or the heating element may comprise an electrical resistance heater or a Joule heating device. The heating element may act by radiation, conduction, convection, or the like. Or the heating element may comprise a fluid that is heated at a remote location and that flows through a channel defined in the substrate 7 or in the layer 12 to the vicinity of the microfluidic channel 8.

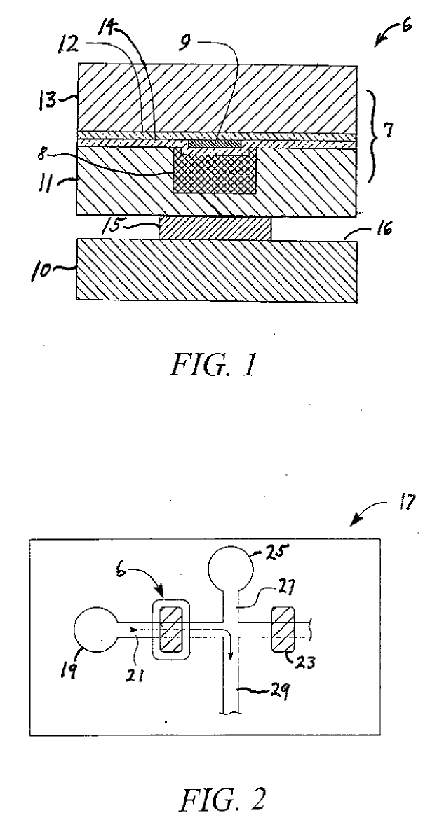

A microfluidic device 17 embodying the invention comprises a microfluidic valve 6 as described above and a microfluidic component 19 in fluid communication with the microfluidic valve through a microfluidic channel 21, as shown in FIG. 2. The exemplary microfluidic device may include other components 23 and 25 interconnected by microfluidic channels 27 and 29.

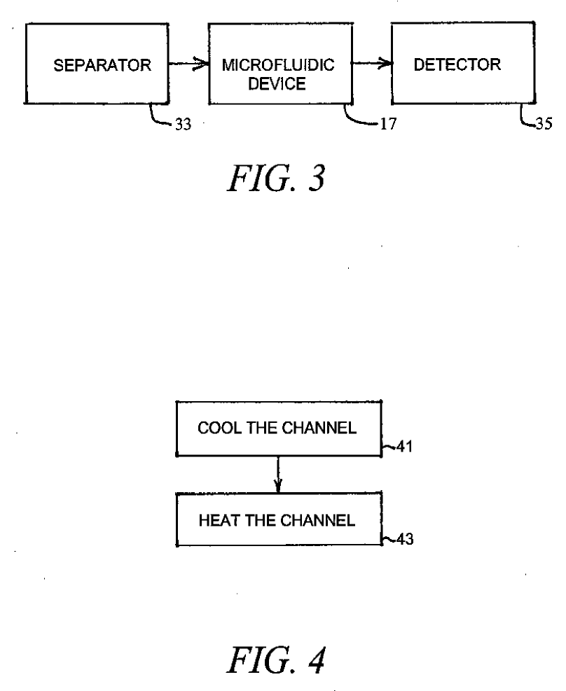

FIG. 3 shows a generalized block diagram of a microfluidic system that includes the microfluidic device 17. A separator 33 is upstream from the microfluidic device. The separator may be any device that separates substances, ions, molecules or the like for analysis. For example, the separator may comprise a liquid chromatograph, an isoelectric focusing device, a centrifuge, a fractionator, or a gel such as an electrophoresis or polyacrylamide gel. The separator may be physically separated from the microfluidic device as shown in FIG. 3, or it may be integrated with, the microfluidic device. The separator may receive an analyte sample and may further separate or purify the sample in preparation for introduction into the microfluidic device.

A detector 35 is downstream from the microfluidic device. The detector may be any device that can identify or characterize molecules or the like provided by the microfluidic device. For example, the detector may comprise a mass spectrometer, a UV/Vis spectrometer, or fluorescence detector.

A method of controlling fluid flow according to the invention, as shown in FIG. 4, comprises cooling 41 a microfluidic channel sufficiently to inhibit flow of a substance therethrough and, when flow of the substance is desired, heating 43 the microfluidic channel to overcome an effect of the cooling and thereby enable flow of the substance. In some embodiments the cooling is performed while heat is being applied as well as at other times.

Although specific embodiments of the invention have been described and illustrated, the invention is not to be limited to the specific forms or arrangements of parts so described and illustrated. The invention is limited only by the claims.

We claim:

1. A microfluidic valve comprising:
a substrate defining a microfluidic channel;
a cooling element adjacent the microfluidic channel that cools a substance in the microfluidic channel sufficiently to inhibit flow of the substance through the microfluidic channel; and
a heating element adjacent the microfluidic channel that warms the substance sufficiently to overcome the cooling effect of the cooling element and thereby enable flow of the substance through the microfluidic channel.

2. A microfluidic valve as in claim 1 wherein the substrate comprises a material selected from the group consisting of metal, ceramic, glass, polymer, and silicon.

3. A microfluidic valve as in claim 1 wherein the substrate comprises photo definable polymer.

4. A microfluidic valve as in claim 1 wherein the substrate comprises a first piece of material having a depression in a surface thereof and a second piece of material that covers said surface to form the microfluidic channel in the depression.

5. A microfluidic valve as in claim 1 wherein the cooling element is selected from the group comprising thermoelectric devices and Peltier devices.

6. A microfluidic valve as in claim 1 wherein the cooling element comprises a conduit and a fluid coolant therein.

7. A microfluidic valve as in claim 1 wherein the heating element comprises a resistive heating element.

8. A microfluidic valve as in claim 1 wherein the heating element comprises a radiative heating element.

9. A microfluidic valve as in claim 6 wherein the radiative heating element comprises a source of electromagnetic radiation having a wavelength between the RF spectrum and the ultraviolet optical spectrum.

10. A microfluidic valve as in claim 7 wherein the radiative heating element comprises a laser.

11. A microfluidic valve as in claim 7 wherein the radiative heating element comprises a microwave energy source.

12. A microfluidic device comprising a microfluidic valve as in claim 1 and a microfluidic component in fluid communication with the microfluidic valve.

13. A microfluidic system comprising a microfluidic device as in claim 12 and a separator in fluid communication with the microfluidic device.

14. A microfluidic system as in claim 13 wherein the separator is selected from the group consisting of a liquid chromatography an isoelectric focusing device, a centrifuge, a fractionator, and a gel.

15. A microfluidic system as in claim 13 and further comprising a detector in fluid communication with the microfluidic device.

16. A microfluidic system as in claim 15 wherein the detector comprises a mass spectrometer.

17. A microfluidic valve comprising:
a substrate defining a microfluidic channel;
means for cooling a substance in the microfluidic channel sufficiently to substantially close the microfluidic channel to fluid flow; and
means for heating the substance sufficiently to overcome any cooling and thereby substantially open the microfluidic channel to fluid flow.

18. A microfluidic system comprising a microfluidic valve as in claim 17, analysis means in fluid communication with the microfluidic valve, separation means for providing a substance for analysis to the microfluidic valve, and means for detecting an output from the analysis means.

19. A method of controlling fluid flow comprising cooling a micro fluidic channel sufficiently to inhibit flow of a substance therethrough and, when flow of the substance is desired, applying heat to the microfluidic channel to overcome an effect of the cooling and thereby enable flow of the substance.

20. A method as in claim 19 wherein cooling the microfluidic channel is performed while heat is being applied to the microfluidic channel as well as at other times.
